(19) United States
(12) Patent Application Publication
(10) Pub. No.: US 2019/0392471 A1
(43) Pub. Date: Dec. 26, 2019

(54) Equality network mobile app or equal economy process

(71) Applicant: Johnny Arturo Rodriguez Cardona, San Juan, PR (US)

(72) Inventor: Johnny Arturo Rodriguez Cardona, San Juan, PR (US)

(21) Appl. No.: 16/019,470

(22) Filed: Jun. 26, 2018

(51) Int. Cl. G06Q 30/02; H04W 4/21; H04W 4/021; H04W 4/23; G06Q 50/00

(52) U.S. Cl. CPC G06Q 30/0217; H04W 4/21; G06Q 30/0249; H04W 4/23; G06Q 50/01; H04W 4/021

(57) ABSTRACT

A social network software designed to increase income equality. In other words, a social network that pays individual users with equality IF they make a sale. I want to solve income inequality with the proper team of skilled and talented people. Therefore, having an issued patent can help secure the investment so we can help other countries, and ours, have better access to food, education and health care.

### CROSS REFERENCING

Referencing PPA 62525,589 filed on Jun. 27, 2017

A social network that pays individual users with equality IF they make a sale

### SEQUENCE LISTING

A portion of the disclosure of this patent document contains material with its subject to copyright or mask work protection. The copy right or mask work owner has no objection to the facsimile reproduction by anyone of the patent documents or the patent disclosure as it appears, in the patent and trade mark office patent file or records, but other wise reserves all copy righted rights what so ever.

### Before Step 1

Users register their information using the conventional forms that stores user account information in memory as a conventional database.

For convenience, the term save in memory means storing data in a conventional database and in a conventional data center.

So each time the term save in memory is used instead of saying storing in a conventional database and a conventional data center, we are just gonna say saving in memory.

### After Registration

Users have the option of taking a conventional personality test. It stores in memory their personality attributes then allows them to see accounts with similar characteristics in the news feed using a sorting algorithm that sorts by matching words.

Example introverted, extroverted people with matching attributes will be able to see each others conventional friend request user interface in the news feed.

### BENEFITS

This application helps meet other individuals with same interests.

Human Resources can build better teams and have improved synergies. This simplifies the hiring process and there is no need to test the person spending less time. After this the user goes to step 1 in the equality network flow chart.

### TECHNICAL FIELD

While this application is related to social entrepreneurship, it is also related to the field of computers and social networks.

### BACKGROUND

We all know that living paycheck to paycheck is a serious problem, just as losing a job which represents a financial discomfort.

Multi level marketing companies have aimed to make people rich over night sadly their plagued by overly inflated prices and dishonesty.
Most companies solve problems for a passive income.
They help few people, usually the ones they employ.

For centuries people have tried to reach an agreement upon what is income equality. Most of the prior art make executives rich and a handful of employees, others barely make ends meet while others are often fired.

From the brightest and most educated men they all have a hard time deciding what is fair when it comes to managers and employees.

### INCOME INEQUALITY

Because of not being able to share resources efficiently for sustaining life, many wars have been fought. Till this day most businesses and countries have not decided on a way of distributing medicine, food and education that doesn't end in countless unnecessary suffering or even worst deaths.

Countless people have died, because of the lack of income equality.

People die daily in the world because of the lack of money to buy medicine, food and education.

I have a dream where income inequality is a situation of the past.

It is time to take a step forward in to the future using technology to solve social problems. This could take us closer to a utopian society.

Michael Porter says that a business that solves social problems for-profit is scalable and has the potential of reaching more people more efficiently than a nonprofit.

Simply because 98% of money is made in business not in charities. Money is what a nonprofit needs to help solve social problems in each country.

The problem targeted is income inequality.

To put it simple, why should companies executives make more money than the employees who do all the work?

Finally I have found with technology a solution that will be shared with the world. A solution to this reality.

### BACKGROUND PRIOR ART

| | | | | Pages, Columns, | |
|---|---|---|---|---|---|
| | | | | Lines, Where | |
| | | | Name of | Relevant | |
| | | | Patentee or | Passages or | |
| | Pat. No. | | Applicant of Cited | Relevant Figures | |
| Cite No.¹ | Pub. No. | Publication date | Document | Appear | Problem targeted |
| 1 | U.S. Pat. No. 10,075,521B2 | 2013 Feb. 26 | Ron | The title has the | Matching names |
| | | | HirsonNicholas | terms equality | in a network with |
| | | | Reidy | network | equality |
| 2 | US20120158589 A1 | 2012 Jun. 21 | Edward | Title and abstract | Claims another |
| | | | KatzinJulian Hua | | authentication |
| | | | Visa International | | method, was |
| | | | Service | | abandoned. |
| | | | Association | | |
| 3 | U.S. Pat. No. 9,710,812B2 | 2017 Jul. 18 | PayPal Inc | Abstract a | Authentication of |
| | | | Thomas Anthony | method for | payments |
| | | | DoranDennis | providing social | between to |
| | | | Warren Koo Tze | network | entities, in a |
| | | | Mew | payments | social network. |
| 4 | U.S. Pat. No. 8,494,914B2 | | Gregory J. | Abstract | Make merchants |
| | | | Mesaros | Says the buyers | lower prices by |
| | | | Valentine | have incentives | selling in bulk |
| | | | Communications | to become | orders listed in |
| | | | LLC | prosumers AKA | the social |
| | | | | to promote and | network |
| | | | | sell the product. | |
| 6 | U.S. Pat. No. 8,229,819B2 | 2012 Jul. 24 | Victoria Ransom | Claims | Promoting |
| | | | Alain Chuard | | coupons and |
| | | | Google llc | | vouchers on a |
| | | | Wildfire | | social network |
| | | | interactive inc | | where users can |
| | | | | | post they're own |
| | | | | | fotos and videos |
| 7 | U.S. Pat. No. 8,583,480B2 | 2013 Nov. 12 | Patrick M. Byrne | Claims | General Social |
| | | | | | network |
| | | | Overstock com | | Advertising and |
| | | | Inc | | commissions. |
| 8 | U.S. Pat. No. 14,226,190 | 2014 | Naomi Felina | Claims | Organizes groups |
| | | | Moneypenny | | of people and |
| | | | Steven Dennis | | influencers to |
| | | | Flinn | | advertise on the |
| | | | | | groups of people |
| | | | | | in real time. |
| 9 | U.S. Pat. No. 8,560,385B2 | 2013 Oct. 15 | Ron Atazky Ehud | | |
| | | | Barone | | |
| | | | Bees and Pollen | | |
| | | | Ltd | | |
| | | | SWAAYED, INC. | | |
| 10 | U.S. Pat. No. 9,466,077B2 | 2016 Oct. 11 | Inventor Vinay | Claims | A search engine |
| | | | GoelRahul S. | | that tracts user |
| | | | KulkarniSubramanya | | activity on many |
| | | | Srikanth | | social networks |
| | | | BelwadiSiddartha | | and websites to |
| | | | NaiduRamanathan | | show other users |
| | | | V. Guha | | what other |
| | | | Current Assignee | | acquaintances |
| | | | Google LLC | | are doing or like |
| | | | Original Assignee | | hence creating |
| | | | Google LLC | | word of mouth |
| | | | | | advertising. |
| 11 | US20110270719 A1 | 2011 Nov. 3 | Anthony Scott | Claims | A social network |
| | | | hollars, Jeffrey | | that calculates |
| | | | Daniel | | commissions |
| | | | Thompson, Jeff | | upon the number |
| | | | Wilhelms. | | of subscribers |
| 12 | US20110276408 A1 | 2011 Nov. 10 | Sarah Elizabeth | Claims | Advertising |
| | | | Toole | | targeted to |
| | | | | | personality types |
| 13 | U.S. Pat. No. 9,270,778B1 | 2016 Feb. 23 | Stephen J | Claims | Matching users |
| | | | Brown | | by they're |
| | | | Invently LLC | | personality type |
| | | | | | in a social |
| | | | | | network |

### Non Patent Literature

| Date of publication | Scripture or work title | Relevant section | Target problem |
|---|---|---|---|
| 2000 | Meritocracy and | Introduction | Income inequality |
| | economic inequality | | |
| | By Kenneth arrow, | And the whole book. | Most political policies |
| | Samuel bowless, | | are ineffective because |
| | Steven Durlauf | | people have a hard time |
| | Published by Princeton | | deciding on what is fair. |
| | University Press | | |
| c. 55 | 2 Corinthians | chapter 8 verse 14 | Equalizing needs of one |
| | | | another. |
| Relatively new | Sola.ai | Pays users for posting | Pays users for using for |
| | | in crypto currency. | posting using a crypto |
| | | | currency. |
| 2016 | Steemit | Pays users for posting | Pays users for posting |
| | | in crypto currency. | in crypto currency. |
| Relatively new | Alphabit | Pays users for posting | Pays users for posting |
| | | in crypto currency. | in crypto currency. |
| 2012 | Futurenet | Pays users for posting | Pays users for posting |
| | | in crypto currency. | in crypto currency. |

### SUMMARY

A social network that pays individual users with an equality commission IF they make a sale.

A computer implemented method for a social network with an integrated equality store with means for paying the equality commissions comprising of the execution of a series of steps done on a processor:

Receiving information from individuals and companies and their corresponding said equality commissions, then storing them in a memory storage device,

Storing in said memory when a person shares a post, an advertisement will appear on the post, if another person interacts with said post and buys from said equality store, said person gets a equality commission from said memory.

A GPS later stores the address of this individual users purchase in said memory. In order to balance the number of brands per region, an algorithm makes sellers more exclusive in a predetermined region.

IF a company sells in said equality store the algorithm allows said company to advertise free of cost this information is immediately stored in said memory.

Whereby

Individuals get paid by sharing media, companies get more cost effective advertising and an army of people promoting their brand, the middle and lower class are encouraged and supported enough to grow and reach sales as fair as their higher class colleagues, reducing poverty and saving the middle class.

### Term Definitions

Memory=An electronic chip that stores information. In this context when we say memory we are referring to local memory on the computer, later copied and passed to a larger memory storage in a server room. If we retrieve information from memory and said information is not available locally, it will be searched in the memory stored in the server rooms.

Algorithm=Is a list of instructions similar to a cooking recipe in a sense that instructions are executed in a predetermined order in the said processor of the computer.

Sorting=Arrange systematically in groups; separate according to the type, class, etc.

Flag=In computer science, a flag is a value that acts as a signal for a function. The value of the flag is used to determine the next step of a program. In simpler terms a flag is a signal to help the computer decide what to do next.

Issuer ID=Greater string number, identifies the issuer of the link.

Transaction ID=Identifies the transaction, between the issuer and the buyer.

ID=abbreviated version of the word identification in all instances across de document, It is an abbreviation used in all the document for easier reading.

Link=A internet address written in HTML or similar languages that directs the user to page available on the internet.

Promoter=The person that shared a link to a post or uploaded a post.

Post=A graphic containing a picture or video available on screen so others can see.

Equality commission function=is the function that stores in memory the amount of money a person gets for helping in the promotion of a product or service.

IF=If statement in computer science means a conditional statement that, if proved true, performs a function or displays information else perform another action. Heres an example IF light=green then gol else stop. If the condition of the if statement is not true the instructions of the if statement will not execute, the “else” part will execute when a else statement is present.

### Part Names Page A

### User Interface A

A=A conventional user interface page.

1A=A conventional text label.

3A=A conventional search bar.

5A=A conventional scroll region.

7A=A conventional text label.

9A=A conventional text button.

### Conventional Screen Features

1H=A conventional screen clock

3H=A conventional battery level indicator

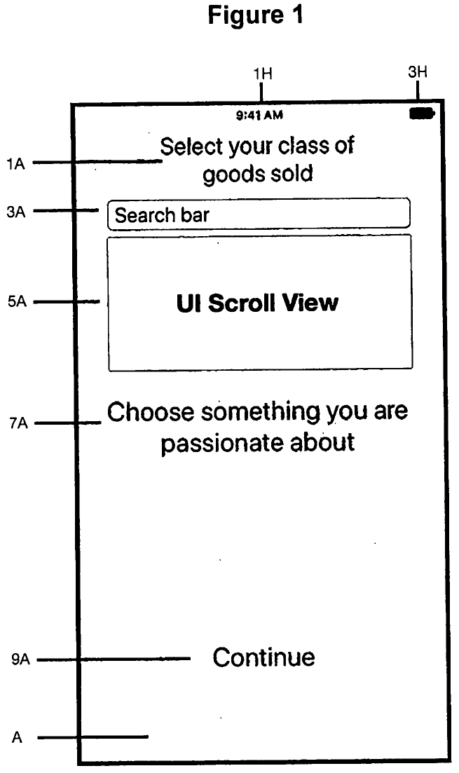

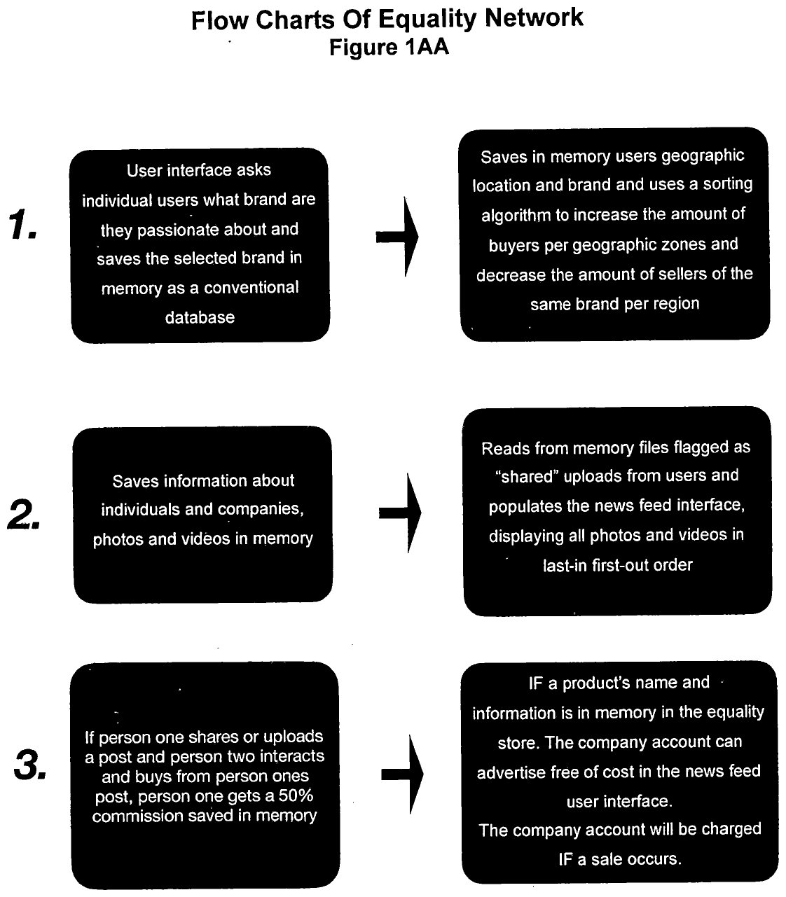

### STRUCTURE OF FIG. 1

### Detailed Description

### User Interface A

1A=The text label 1A tells the user to choose one of the available brands of a specific product.

3A=The search bar 3A is available for conventional searching of a brand.

5A=The scroll region 5A is there so the user, can browse conventionally between brands of specific products.

7A=The text label 7A tells the user that they are going to pick a product brand that he is familiarized with.

9A=The button 9A is there so the user can continue on to the next view, which is the option of the personality quiz.

### Function Of FIG. 1

### Detailed Description

High Level Function Page A

This explains the logic of page A in simpler terms.

This page exists for the purpose of assigning each user a specific product from a brand. So advertisements will appear based on the selected product brand. IF the user uploads a picture or video the selected product brand will display its current advertising video or photo instead of the users photo or video at a predetermined time in page C or “news feed”

The algorithm will sort a lower amount of sellers per geographic region and a greater amount of buyers per geographic regions, the number of buyers will be greater than the number of sellers. After a predetermined amount of time a notification will ask the user if he wants to change his class of goods. IF the user accepts a segue will take him to page A.

### Low Level Function A

This explains the “how” of page A in more technical detail.

The user interface is loaded from memory in to the screen in a conventional fashion.

### Initializing User Memory Table

A function will generate the following parameters for the users account information table: Users Issuers ID, Users buying ID, Users interaction ID, Users location(country or region) and class of goods sold. IF the GPS function isn't available, user will be prompted to select his country.

User Account Information Table
This values will be initialized for each user.
Part 1

| Defitions | User Name | Users issuers ID | Users buying ID | Users interaction ID |
|---|---|---|---|---|
| Value | String variable | Unique constant | Unique constant | Unique constant |
| | | string even | string odd | odd number |
| | | numbers | numbers. | integer |
| Purpose | So users can | Used to identify | Used to identify | Used to identify |
| | identify each other. | who published a | who bought from | the last person to |
| | | post and who was | the advertisement | interact with a |
| | | the last person to | on a post. | post. |
| | | share a post. | | |

Part 2

| | | Class of goods | Users personality | Total commissions |
|---|---|---|---|---|
| Defitions | Users location | sold | type | earned |
| Value | Users address | Variable string. | Variable string. | String variable |
| Purpose | Used to determine | This information | To identify the users | To know the |
| | what local posts to | helps choose the | personality type. In | amount of money |
| | be displayed in the | type of | order to display | earned. |
| | scroll region. | advertisements that | posts from users | |
| | | will be displayed in | with compatible | |
| | | the users post. | personalities. | |

The values from this table will be queried later on for identifying:

Who is the seller of a post and who is the buyer?

Who interacted with a post and who shared the post or upload the post?

The scroll region 7C is populated from brands registered in memory in the local products table.

If the user selects one brand and hits the continue button, the users selection is stored in memory with the users local account information. After the users selection is stored in memory, a segue algorithm is called to show page B on screen.

The proper information will be queried in a conventional way, the tables help.

### GPS Sorting Algorithm

A sorting algorithm in the server side will decrease, the amount of sellers of the same product brand per geographic regions. So the amount of buyers is increased per geographic zone. The result is a greater number of buyers and a lower number of sellers. The buyers are defined as users who do not sell the same product.

### If a Class is Being Used by Too Many Users.

The sorting algorithm will block users from getting a class of goods sold that is already used by a predetermined number of users.

A query to the user accounts information table will reveal the users or region country. Once the program has the users country, it can search the corresponding products table. If a product ID in the product table is in the class of goods sold of a predetermined number of users then it will filter it from the select class of goods sold user interface scroll region to avoid too many people selling the same product in a geographic region.

### Advertising Function Queries

Later on if the user posts a picture or video in the news feed page C, the product selected will be queried in memory from a function that will show on screen a picture or video of the corresponding advertisement, instead of the users respective post for a predetermined period of time. This information comes from the class of goods sold in the product table.

The Product Table And Selecting Class Of Goods Sold
Part 1

| | | | Product | Product | Product | |
|---|---|---|---|---|---|---|
| Definitions | Seller ID | Product ID | description | brand | rating | Comments |
| Value | Unique String | Unique string | String variable | String variable | Integer | String array |
| | | | | | | variable |
| Purpose | To identify the | To identify the | To describe | To tell | To tell | Allows buyers |
| | seller of a | product so it | the product so | potential | potential | to |
| | product so the | can be written | that potential | buyers the | buyers the | communicate |
| | equality | precisely in | buyers can | brand that is | experience | with each |
| | commission | invoice | understand if | behind the | other buyers | other freely |
| | function can | receipt. | they need | goods or | have had with | about their |
| | route the | | their product. | service. | the goods or | experience |
| | payment and | | | | services. | with the goods |
| | deduct the | | | | | or services. |
| | commission. | | | | | |
| | This one gets | | | | | |
| | copied from | | | | | |
| | issuer ID. | | | | | |

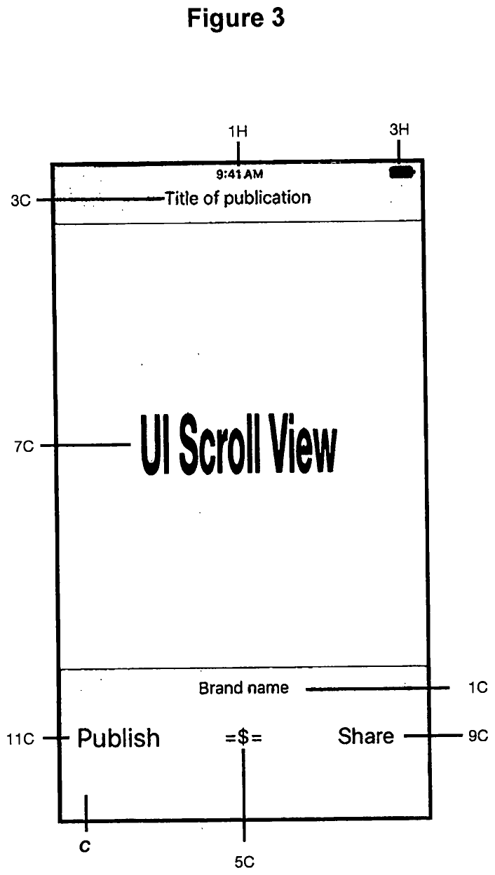

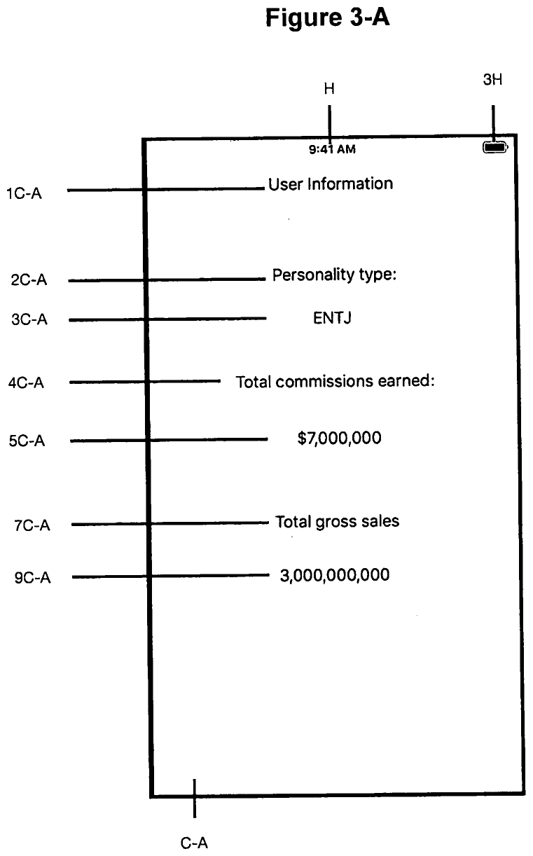

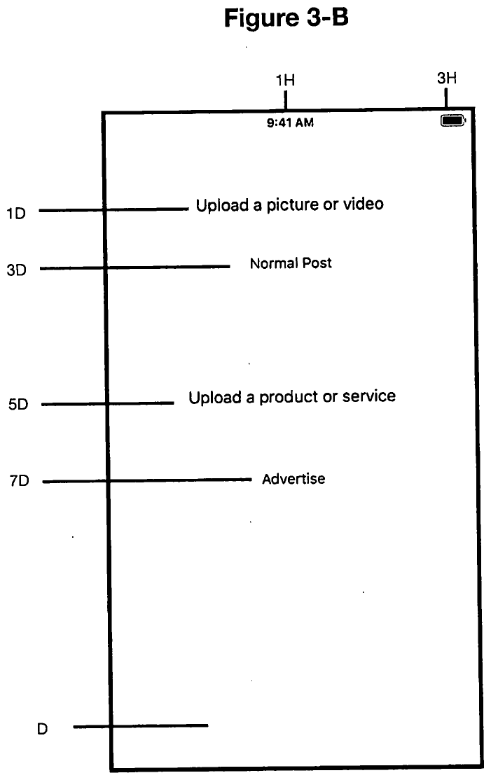

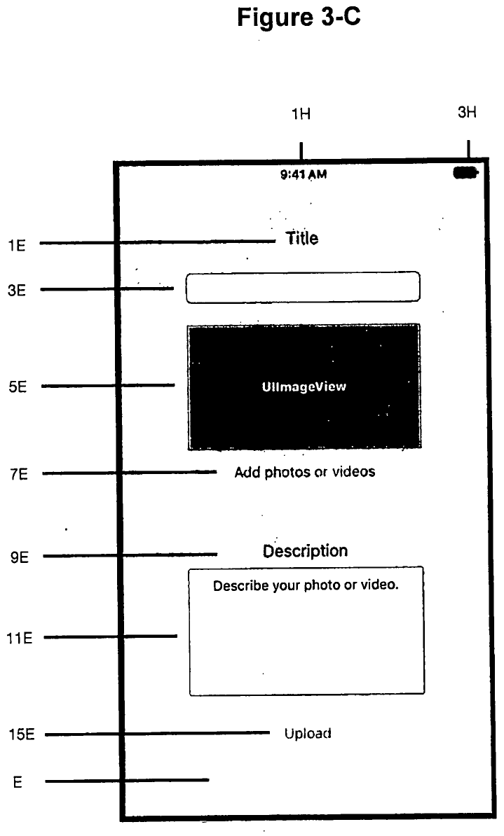

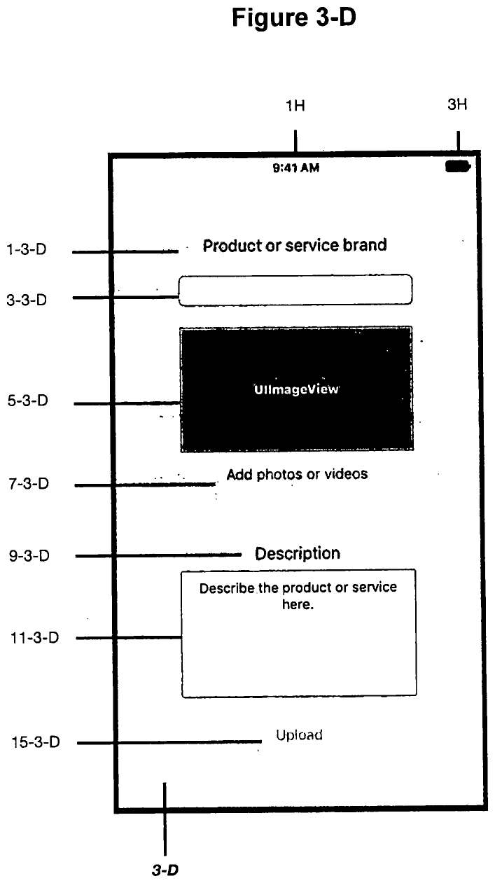

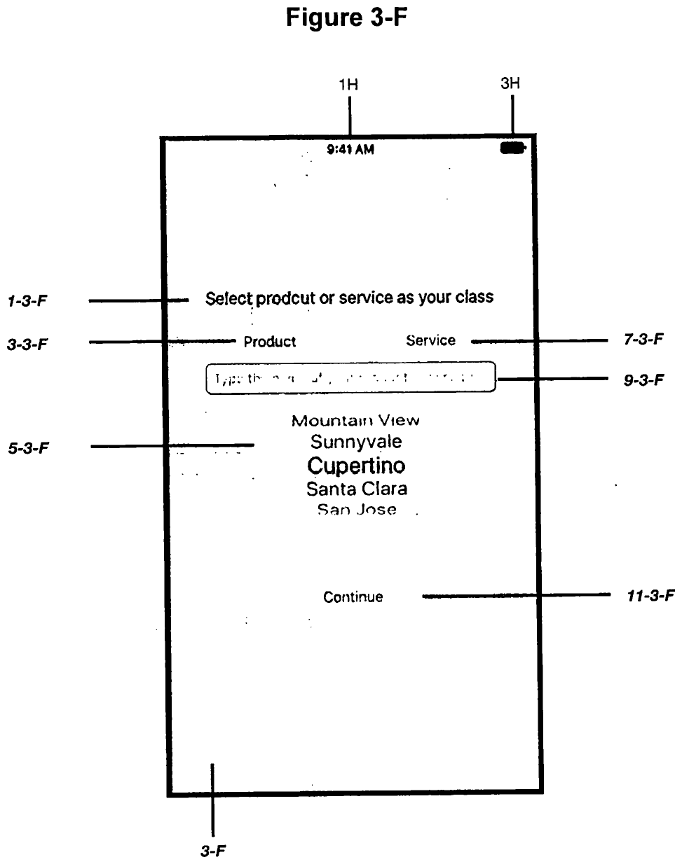

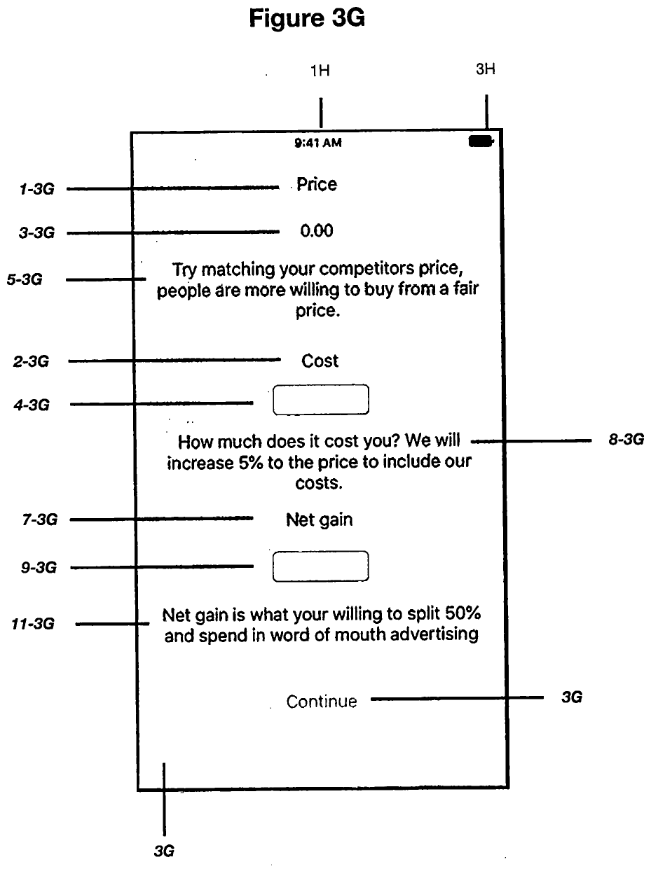

Part 2

| | | Photo or | | | | |
|---|---|---|---|---|---|---|
| | Class of | video of | | | | |
| Definitions | goods sold | product | Country | Time stamp | Price | Net gain |
| Value | String | Multi media | String | String | Decimal | Decimal |
| | | | | constant | variable | Variable |
| Purpose | This value is | This will be | It helps | It helps | The amount | The amount |
| | used in select | displayed in | identify where | identify the | of money to | of money to |
| | your class of | on FIG. 3. | the product is | last product | be paid for a | be split 50% |
| | goods sold in | | being sold. | uploaded. | product or | to pay users |
| | FIG. 1. | | | | service. | for promoting |
| | | | | | | a product. |

This table will be queried from the clouds memory IF its populated. The table will be queried by the country of the user, IF this table is not fully populated then the user will be able to select from the available products in his region. IF there aren't any entries in the product table then a message in the text field will display no products available in your country.

A notification will keep alerting the user when a product is available in his country.

A function will continuously check in the background until a product is available in the users country and send a notification to the user.

### Operation FIG. 1

### Detailed Description

### User Interface Page A

This interface tells the user to pick a brand he likes.

So he later can receive commissions from the sales of the product he likes each time an advertisement on the users photos or videos makes a sale.

1A=Text label 1A tells the user to choose one of the available brands of a specific product.

3A=Search bar 3A is available for conventional searching of a brand.

5A=Scroll region 5A is there so the user can browse conventionally between brands of specific products.

7A=Text Label 7A tells the user to pick a product brand that he is familiarized with.

9A=Button 9A is there so the user can continue on to the next view, which is the option of the personality quiz.

### Part Names Page B

### User Interface B

B=A conventional user interface page.

1B=A conventional text label.

3B=A conventional scroll region.

5B=A conventional text label.

7B=A conventional button.

9B=A conventional button.

### Conventional Screen Features

1H=A conventional screen clock

3H=A conventional battery level indicator

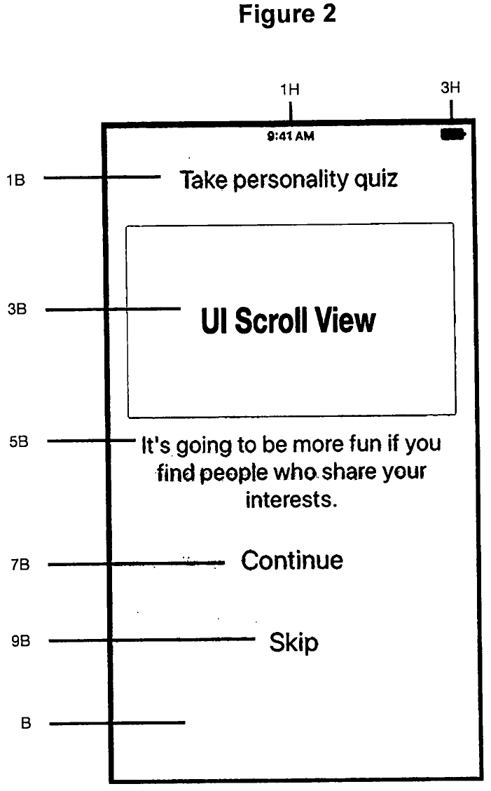

### Structure Of FIG. 2

### Detailed Description

### User Interface B

1B=The text label 1B Tells the user to take said personality quiz.

3B=The scroll view region 3B has said conventional personality quiz questions.

5B=The text label 5B tells the user the benefits of taking the quiz.

7B=The button 7B saves in memory the users answers from the quiz.

9B=The button 9B segues in to the news feed view also named page C.

### Function Of FIG. 2

### Detailed Description

### High Level Function Page B

This Explains The Logic Of Page B In Simpler Terms.

This page shows the user the quick benefits of taking the personality quiz.

It helps the user to be able to later on see in the news feed page other users with similar personality attributes. This is so that users with similar interests can interact. After a predetermined amount of time a notification will ask the user if he wants to change his personality type if the user accepts a segue will take him to page B.

### Low Level Function B

This Explains The “How” Of Page B In More Technical Detail.

The page tells the user the benefits of taking the personality quiz in a conventional fashion shown in 1B and 5B.

The Scroll region 3B shows the questions of the conventional personality quiz.

Questions and answers are populated from memory in to 3B.

If the person selects an answer and hits the continue button, a function to save in memory is executed. If one question and its answer is saved in memory and the continue button is pressed then the next question will appear on 3B.

Until all the questions have been answered from memory the looping algorithm will stop when the last question is displayed.

If all questions have been answered then the continue button triggers a segue function to the news feed page.

### Results Of The Personality Quiz

The results are saved in memory in the user accounts information table.

### Memory Processing

The personality quiz questions are populated from the personality quiz table.

If the user takes the personality quiz the result is processed in the conventional way and then stored in the user account information table.

The personality quiz table will be loaded in memory by the programer.

If the user dose not complete the quiz and skips, the results are deleted and the looping algorithm resets to the beginning.

| Definitions | Questions | Answers |
|---|---|---|
| Value | Constant string array | Constant integer array |
| Purpose | The array contains all questions | The users answers are |
| | and is queried by a while loop. | stored here. |

### Operation FIG. 2

### Detailed Description

### User Interface B

This interface tells the user to fill up the questions of a conventional personality quiz. Then there are many benefits from interacting in the news feed with like minded individuals.

Text label 1B Tells the user to take a personality quiz.

Scroll view region 3B has conventional personality quiz questions.

Text label 5B tells the user the benefits of taking the quiz.

Button 7B saves in memory the users answers from the quiz.

Button 9B segues in to the news feed view.

### Part Names Page C

### User Interface C

C=A conventional user interface page.

1C=A conventional text label.

3C=A conventional text label.

5C=A conventional button for seeing your total commissions earned.

7C=A conventional scroll region here you can see photos and videos people uploaded.

9C=A conventional text button.

11C=A conventional text button.

17C=A conventional text button.

### Conventional Screen Features

1H=A conventional screen clock

3H=A conventional battery level indicator

### Structure Of FIG. 3

### Detailed Description

### User Interface C

Text label 1C tells the user the name of the brand that the on screen advertisement or post corresponds.

Text label 3C tells the user what is the title of the picture or video on the screen.

Button 5C shows you the sum of commissions along with your accounts information.

Scroll region 7C is where all the pictures and videos individuals and companies post will be available to bee seen on a last-in first-out fashion.

9C is the button for sharing photos and videos, with a link so others can see the post.

11C is the button to upload a picture or video so people can see in 7C.

### Function Of FIG. 3

### Detailed Description

### High Level Function Page C

This explains the logic of page C in simpler terms.

1C and 3C are there to inform the user of the brand that's being represented by the post in 7C.

5C is to inform the user on the grand total of commissions earned and personality type.

7C here's where people are going to see photos and videos they posted or that others posted.

7C IF a person interacts with a post of a video or photo and then buys the issuer(person who uploaded) the post gets a commission or the last one to share the post.

9C the post that appears on 7C or that was touched last will be shared to the contacts on the user phone or by a link to other applications for example Facebook or Twitter or Youtube etc.

The link routes the person who activated it to download the equality application IF the user hasn't done it, and to the post itself.

11C is for conventional uploading to the news feed 7C which is a public news feed, users in the region can see the posts. The region is a geographic zone per country.

11C is just a conventional menu for user setting, password changing etc.

### Low Level Function C

This explains the “how” of page C in more technical detail.

### Text Labels 1C And 3C

1C and 3C will be populated from memory from the current post IF user scrolls over a post in 7C. IF image or video that is embedded in the scroll region is touched or tapped or interacted with it.

A function will query the post id.

After the post ID is retrieved from the local posts table, a query to the proper string names will be executed. The string names that have to be retrieved from memory to populate 1C and 3C are title and brand.

On other computers, 1C and 3C receive their string values from the local post table in memory by first calling the GPS function or users account information table in order to display on 7C the local posts of the users region.

5C will query the users account table in memory to display the total commissions earned.

### Initializing Scroll Region 7C

Check users GPS address or query the user information account table for the address or country.

IF users address and or personality type matches one of the existing local post tables in memory, then the user can see photos or videos and upload these to his corresponding local post address table in memory.

Else, IF no local post table primary keys match the users address and or personality type, then the program will create a region in memory called local posts table and set its primary key to a unique country address matching the users current address. The proper information will be queried in a conventional way and the tables are there to help.

Local Posts Table Memory
Part 1

| Definition | Issuers ID | Interaction ID | Location | Time Stamp | Photo or video |
|---|---|---|---|---|---|
| Value | Unique number | Unique number | Users address. | Is used to date | A data file |
| | integer | integer | | each transaction | containing an |
| | | | | and constant | image or a video. |
| | | | | value. | |
| Purpose | Identifies the | Used to identify | Used to | For accounting | This is the region |
| | person who | the last person to | determine where | purposes. | in memory where |
| | uploaded a photo | interact with a | a transaction | | the pictures will |
| | or video. Also | post. | took place. | | be stored and |
| | used to identify | | | | retrieved. |
| | when a person | | | | |
| | shares a photo | | | | |
| | or video via a | | | | |
| | link. | | | | |

Part 2

| | | Description of | Brand of | Personality | |
|---|---|---|---|---|---|
| Definition | Title of post | post | advertisements | types | Primary key |
| Value | String variable | String variable | String variable | Array of strings | Unique string |
| | | | | | constant |
| Purpose | This is where the | This is where the | This is where the | It's optional. | Used to identify |
| | title of each post | description of the | advertised brand | Contains a list of | the correct |
| | will be stored. | post will be | name will be | similar | local posts |
| | | saved in | stored. | personalities. | table if the |
| | | memory. | | | GPS function is |
| | | | | | not available. |

To query from this table in the cloud the developer will first call the GPS function to confirm the users address and use the country or region to access the table. IF its not possible to use the users location as a primary key to query the proper local posts table then a unique primary key ID string will be assigned to the table and will be used as primary key instead to access the local post table. This unique string should be the name of the geographic region, for example city or town.

### Populating the Scroll Region 7C

7C will be populated from a region in memory called current local post table in a last-in first-out fashion algorithm and or by people with same personality attributes in memory IF they match the primary key address of one of the local post tables in memory else a new one is created as explained in the previous heading.

IF user activates an advertisement on 7C it will trigger a segue to page D also named as the equality store. Programmer is advised to use proper exception handling because each computer is different, the proper guidelines may vary.

Product Table Advertisements In 7C
Part 1

| | | Photo or | | | | |
|---|---|---|---|---|---|---|
| | Class of | video of | | | | |
| Definitions | goods sold | product. | Country | Time stamp | Price | Net gain |
| Value | String | Multi media | String | String | Decimal | Decimal |
| | | | | constant | variable | Variable |
| Purpose | This value is | This will be | It helps | It helps | The amount of | The amount of |
| | used in select | displayed in | identify where | identify the | money to be | money to be |
| | your class of | FIG. 3. | the product | last product | paid for a | split 50% to |
| | goods sold in | | has been sold. | uploaded. | product or | pay users for |
| | FIG. 1. | | | | service. | promoting a |
| | | | | | | product. |

Part 2

| | | | Product | Product | Product | |
|---|---|---|---|---|---|---|
| Definitions | Seller ID | Product ID | description | brand | rating | Comments |
| Value | Unique String | Unique string | String variable | String variable | Integer | String variable |
| Purpose | To identify the | To identify the | To describe | To tell | To tell | Allows buyers |
| | seller of a | product so it | the product | potential | potential | to |
| | product so | can be written | so that | buyers the | buyers the | communicate |
| | the equality | precisely in | potential | brand that is | experience | with each |
| | commission | invoice | buyers can | behind the | other buyers | other freely |
| | function can | receipt. | understand if | goods or | have had with | about their |
| | route the | | they need | service. | the goods or | experience |
| | payment and | | their product. | | services. | with the |
| | deduct the | | | | | goods or |
| | commission. | | | | | services. |
| | This one gets | | | | | |
| | copied from | | | | | |
| | issuer ID. | | | | | |

This table will be queried from the database to place advertisements on users posts. This table will be queried by the country or region of the user. The advertisements will be queried in a last-in first-out fashion.

A algorithm will detect the last advertisement by the time stamp in the table to display in the scroll region 7C.

### Advertisement Loading Function

IF the photo or video on 7C is triggered a function will activate a timer that will display an advertisement after 1-5 minutes. IF the timer has reached its time limit it will query from the local products table using the country region or address strings to load an advertisement instead of the initial users photo or video for the predetermined duration of the advertisement. Adds can be displayed in the conventional way last in first out from the local products table. The advertisement displayed on a users post will match the users class of goods sold.

If advertisements match users class of goods sold then display picture or video of advertisement instead of users post else display users post.

### Advertisements are Free if the Product is Sold in the Equality Store on Page F or Screen G

Users can advertise freely if the product or service they provide is sold in the equality store.

### Double Clicking or Tapping an Advertisement

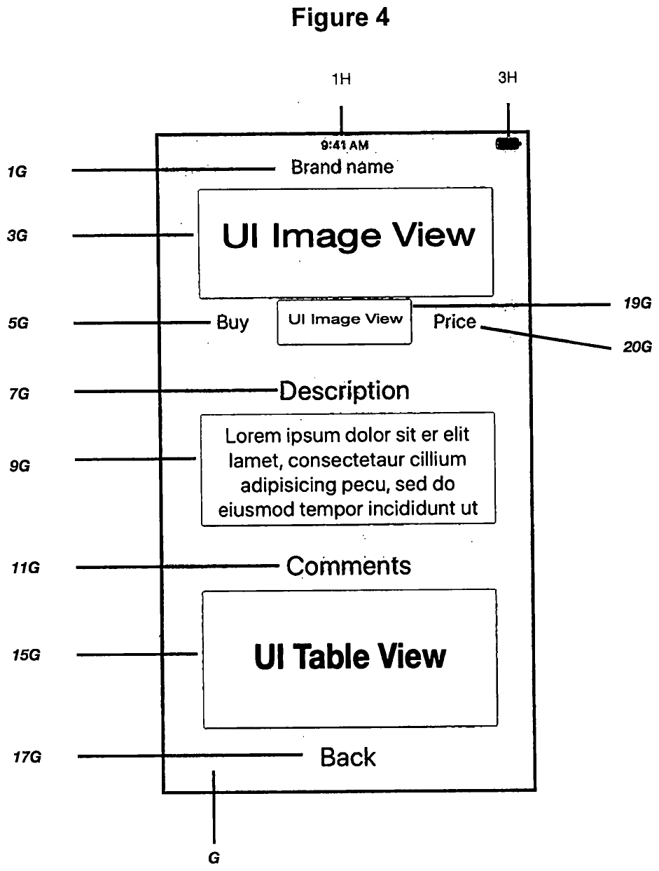

The product ID from the local product table will be used to segue to the equality store page FIG. 4. IF the picture on the advertisement is tapped or clicked or touched, it will trigger the segue to the products description page in FIG. 4.

Before segueing the table below will be initialized. The post issuers ID is queried from the post ID in the local posts table while the buyers ID is queried from users account information table. On the other hand, the sellers ID is queried from the product ID of the advertisement from the product table. And the product ID comes from the local product table.

### Before Segueing to Equality Store

The values mentioned before will be saved in the interactions table shown below.

| Definition | Issuer ID | Seller ID | Post ID | Product ID | Time Stamp |
|---|---|---|---|---|---|
| Value | Unique string | String constant | Unique decimal | String constant | Is used to date |
| | even number | | numbers and | | each |
| | and constant | | constant value. | | transaction and |
| | value. | | | | constant value. |
| Purpose | identifies the | Identifies the | Is read by the | Identifies the | For accounting |
| | issuer of the | person or entity | equality | product being | purposes. |
| | link or post. | that sells a | commission | sold, for | |
| | | product, so the | routing | shipping and | |
| | | money can be | functions. | accounting. | |
| | | transferred | | | |
| | | upon a sale. | | | |

Before segueing in to the equality store page (FIG. 4), the following information will be accessible and stored locally so a transaction can be processed IF the buy button is activated. The information required is shown in the table titled: Interactions Table. The proper information will be queried in a conventional way, the tables help.

### More On Populating 7C

A function queries from the Local Posts table the title of the post and the description of the post.

So users can see the titles and descriptions of posts on screen by conventional text labels. This happens when the page is first initialized.

### Scroll Region Equality Commission Function Memory Preparation

IF user activates the advertisement button then query the following information from the local posts table to the user interactions table so later in the store page IF the user buys the equality commission can query from the users local memory all the information necessary to identify the seller, the post and the buyer.

The local posts table is saved in the cloud and locally so all users can access IF their location changes. So copying the information from local posts to the users local computer memory greatly reduces the time it takes to process an order. Reducing the stress or load of processing power on the server side.

The function will query from local posts table and user accounts information which is located at the cloud and in local memory the following information: issuers ID, interaction ID, location, timestamp and brand of advertisements. These values are to be saved in the local memory table called user interactions.

Local User Interactions Table

| | Users | | | | | |
|---|---|---|---|---|---|---|
| | interaction | | | | | |
| Definition | ID | Issuer ID | Seller ID | Post ID | Product ID | Time Stamp |
| Value | Unique | Unique | String | Unique | String | Is used to |
| | number | string | constant. | decimal | constant. | date each |
| | integer. | number and | | numbers and | | transaction |
| | | constant | | constant | | and constant |
| | | value. | | value. | | value. |
| Purpose | Used to | Identifies the | Identifies the | Is read by | Identifies the | For |
| | identify the | issuer of the | person or | the equality | product | accounting |
| | last person | link or post. | entity that | commission | being sold, | purposes. |
| | to interact | | sells a | routing | for shipping | |
| | with a post. | | product, so | functions. | and | |
| | | | the money | | accounting. | |
| | | | can be | | | |
| | | | transferred | | | |
| | | | upon a sale. | | | |

### IF Users Interact With Posts

A function will query from the local posts table, the issuers ID and save it in a new row in the users interactions table. The program will query the post ID from the local posts table of the users location. Then it will query from the users Local Account Information table, the users interaction ID, and finally save the time stamp of when the interaction occurred.

### Share Button

9C if this button is activated, the post that is in the center of 7C or the last one touched, tapped or interacted will be shared to selected contacts on the phone of the user or other applications with a link. IF the person whom receives the link, those not have the equality application it will direct him to install and will store a cookie for an Equality Commission for recruiting a new user to be paid to the issuer of the link. A function will query the cookie stored and IF a sale occurs, the issuer of the link receives an equality commission.

### Share Button Memory Processing

If the user shares a posted photo or video, a query to user account information will copy the users issuers ID, location and the title of the post is copied into temporary variables called user shared information.

The user shared information variables are copied and saved in the local post table memory to create a new row with the new issuer ID, location timestamp, brand of advertisements, personality type and the photo or video is simply copied into this row. Also a link is generated to access this post.

### Share Button Link

So a link arrives as a text message.

It directs the user to a web page so a cookie can be stored in the users memory. The web page encourages the user to install the app and has a link to the app-store and or several videos.

Then if the user installs the application, it will open the company web page again to retrieve the cookie and store it again in the users local memory, but now at a deeper more permanent level in the applications file directory.

The cookie has the issuer ID of the link, to ID the person who issued the link and the post ID so when the application opens for the new user after installation. The post that user A shared to new user B after opening the link can be seen in 7C. IF new user B buys from user A's post after opening the link the equality commission function will assign the commission to user A.

### Share Button Equality Commission Function

The information necessary to identify the buyer, seller, promoter and product is saved in the local posts table, User Account Information table and user Interactions table for the Equality Commission Function to work in page F, the store.

### Upload A Post

11C if this button is activated, a function will segue to a conventional page that uploads a picture or video, user enters the title of the post, the brand name will be queried from the users account table that was saved previously in page A.

11C after the upload is complete the post will be stored in a region in memory called current local posts as well as all the other local posts from the geographic region. Files in the local posts memory will be deleted in a first-in first-out fashion.

### Operation FIG. 3

### Detailed Description

C=The page is for seeing local posts from the country of the user.

1C=The label displays the brand of the product displayed on screen.

3C=The label displays the title of the photo or video displayed on 7C.

5C=A conventional button for seeing your total commissions earned.

7C=A conventional scroll region here you can see photos and videos people uploaded.

9C=The button for sharing a photo or video you see on the screen.

11C=The button for publishing or uploading a photo or video.

### Part Names FIG. 3-A

C-A=A conventional user interface page.

1C-A=A conventional text label.

2C-A=A conventional text label.

3C-A=A conventional text label.

4C-A=A conventional text label.

5C-A=A conventional text label.

7C-A=A conventional text field.

9C-A=A conventional text field.

### Conventional Screen Features

1H=A conventional screen clock

3H=A conventional battery level indicator

### Structure FIG. 3-A

C-A=A conventional user interface page for displaying the users account information.

1C-A=The text label says user information.

2C-A=The text label says personality type.

3C-A=The text label says the users personality type.

4C-A=The text label says total commissions earned.

5C-A=The text label displays the amount of money earned.

7C-A=The conventional text field reads: “Total gross sales”

9C-A=A conventional text field displays the total amount of money from sales.

### Function FIG. 3-A

C-A=A conventional user interface page for displaying the users account information.

C-A=As the user interface is instantiated a function will be called that initializes a timer and a while loop that stops IF the timer's value is 15 seconds. After the while loop, there is a function that will segue back to FIG. 3.

1C-A=The text label says user information, it is a constant value.

2C-A=The text label says personality type, it is a constant value.

3C-A=The text label says the users personality type, it is queried from user accounts information table.

4C-A=The text label says total commissions earned, it is a constant value.

5C-A=The text label displays the amount of money earned, queried from the user account information table. The proper information will be queried in a conventional way, the tables help.

7C-A=The conventional text field reads: “Total gross sales”

9C-A=A conventional text field displays the total amount of money from sales. Users who sell products or service on the equality store can see this. So, an IF statement will display “start selling your product or service” IF the user does not have any products associated with his user ID. The information to be displayed here comes from the sum of sales of the users products or services. It is basically the sum of the cost and 50% of the net gain. This information is stored in the users local sales table.

The user can see his commissions earned and his personality type IF he has one else it displays unknown.

### Operation FIG. 3-A

C-A=A conventional user interface page for displaying the users account information.

1C-A=The text label says user information.

2C-A=The text label says personality type.

3C-A=The text label says the users personality type.

4C-A=The text label says total commissions earned.

5C-A=The text label displays the amount of money earned.

The user can see his commissions earned and his personality type IF he has one else it displays unknown.

Users Local Sales Table

| Definition | Gross sales |
|---|---|
| Value | Decimal |
| Purpose | Its value comes from the subtraction of 50% of the |
| | net gain from the price. |

### Part Names Page D

### User Interface D

D=A conventional user interface page.

1D=A conventional text label.

3D=A conventional button.

5D=A conventional text label.

7D=A conventional button.

### Conventional Screen Features

1H=A conventional screen clock

3H=A conventional battery level indicator

### Structure Of FIG. 3-B

### Detailed Description

### User Interface D

D=The page is displayed IF user pressed the publish button on page C.

1D=The text label indicates to the user to press the button below to upload a picture or video.

3D=The button segues the upload page E.

5D=The text label indicates to the user to press the button below to upload a product or service.

7D=The button segues to the upload page F.

### Function Of FIG. 3-B

### Detailed Description

### High Level Function Page D

This Explains The Logic Of Page D In Simpler Terms.

D=The page is displayed if user pressed the publish button on page C.

1D=The text label indicates to the user to press the button below to upload a picture or video.

3D=The button segues to the upload photo and video page E.

5D=The text label indicates to the user to press the button below to upload a product or service.

7D=The button segues to the upload a product or service page F.

### Low Level Function Page D

This Explains The “How” Of Page D In More Technical Detail.

D=The page is displayed if the user pressed the publish button on page C.

1D=The text label indicates to the user to press the button below to go to upload a picture or video.

3D=The button segues to the upload photo and video page E.

5D=The text label indicates to the user to press the button below to go upload a product or service.

7D=The button segues to the upload a product or service page F.

### Operation FIG. 3-B

### Detailed Description

D=The page tells the user to choose the type of upload the user wants.

1D=The heading indicates the purpose of the button below, in this case it is a conventional photo or video post.

3D=The button if activated segues to page E or FIG. 5.

5D=The heading indicates the purpose of the button below, in this case it is uploading a photo or video of a product or service.

7D=The button IF activated segues to page F or FIG. 6.

### Part Names Page E

### User Interface E

E=A conventional user interface page.

1E=A conventional text label.

3E=A conventional text field.

5E=A conventional image view.

7E=A conventional button.

9E=A conventional text label.

11E=A conventional text field.

15E=A conventional button

### Conventional Screen Features

1H=A conventional screen clock

3H=A conventional battery level indicator

### Structure Of FIG. 3-C

### Detailed Description

### User Interface E

E=The page E is for uploading conventional photos and videos to the local post table in memory.

1E=The text label tells the user to write the post's title.

3E=The text field is where the user actually types in the title of the post.

5E=The image or video, if selected using the button below, will be displayed here.

7E=This button is for selecting the image to be presented on 5E.

9E=The text label tells the user to describe the photo or video.

11E=The text field is where the user types in the description of the photo or video.

15E=A GPS function is used to verify that the user's address matches the one in the table of Local Posts or a query to users Account Information. Else then, a new local posts table will be created and the users post will be added to it. Then, the upload button, if activated, will save the post in the local post's table in memory.

15E=If the button is activated and the post has been saved to memory then segue to page C else displays in 1E “internet connection not available”.

### Function FIG. 3-C

### Detailed Description

### User Interface E

E=The page E is for uploading conventional photos and videos to the local post table in memory IF the user's address matches the address of a country else it creates a new table for that address so people with a similar address can see their local posts.

1E=The text label tells the user to write the post's title.

3E=The text field is where the user actually types in the title of the post.

5E=The image or video IF selected using the button below will be displayed here.

7E=This button is for selecting the image to be presented on 5E.

9E=The text label tells the user to describe the photo or video.

11E=The text field is where the user types in the description of the photo or video.

15E=The upload button if activated will save the post in the local posts table in memory IF the users address matches the one on the table by first calling a GPS function to verify that the users address matches the one in the table of local posts, else a new local posts table is Initialized and the users post is added to the new local posts table.

15E=If the button is activated and the post has been saved to memory, then segue to page C else display in 1E “internet connection not available”.

15E=IF post is saved to the local posts table the following information will also be saved from user account information table the issuers ID, a post ID and time stamp shall be assigned.

15E=If button is activated the title and description of the users post shall be saved to the local posts table, along with issuers ID, location, timestamp, photo and video, title of posts, brand of advertisements. So, in the scroll region in 7C the matching class of goods sold product photo or video will be presented. Programmer is advised to use proper exception handling because each computer is different, the proper guidelines may vary, consult the manufacturers specifications or manuals before development. IF there is a matching local posts table save on it else create a new one with user's address and save on it the user's upload.

### Operation FIG. 3-C

### Detailed Description

E=This page tells the user to upload a picture or video.

1E=The label tells the user the following message “title”, so the user can understand he will write a title for this post or leave it blank.

3E=The text field is for writing the title of a photo or video.

5E=The image view is for displaying what the user selected, for his photo or video.

7E=The button is for saving in memory the photo or video and the user's corresponding information in the local post table so others can see what the user wanted them to see.

9E=The conventional text label has the following message “description”, so the user can understand he will write a description for his post.

11E=The conventional text field is where the user will write his description.

15E=The conventional button is where the user will press to save his photo or video in memory, so other people can see what he selected.

### Part Names FIG. 3-D

### Detailed Description

3-D=A conventional user interface.

1-3-D=A conventional text label.

3-3-D=A conventional text field.

5-3-D=A conventional image view.

7-3-D=A conventional button.

9-3-D=A conventional text label.

11-3-D=A conventional text field.

15-3-D=A conventional button.

### Conventional Screen Features

1H=A conventional screen clock

3H=A conventional battery level indicator

### Structure FIG. 3-D

### Detailed Description

3-D=The conventional user interface for uploading a product or service graphic.

1-3-D=The text field has the message “product or service brand”.

3-3-D=The conventional text field is for entering the product or service brand.

5-3-D=The conventional image view is for displaying the selected picture or video.

7-3-D=The conventional button is for selecting a photo or video from the users local memory.

9-3-D=The conventional text label has the message “description”.

11-3-D=The conventional text field is for describing the product.

15-3-D=The conventional button is for uploading to local posts the information required and saving to the product table.

### Function FIG. 3-D

### Detailed Description

1-3-D=The text field has the message “product or service brand.”

3-3-D=The conventional text field is for entering the product or service brand.

5-3-D=The conventional image view is for displaying the selected picture or video.

7-3-D=The conventional button is for selecting a photo or video from the users local memory.

9-3-D=The conventional text label has the message “description.”

11-3-D=The conventional text field is for describing the product.

15-3-D=The upload button IF activated will save the post in the local products table in memory IF the users address matches the one on the table by first calling a GPS function or reading users local account information to verify that the users address matches the one in the table of local products, else a new local products table is initialized and the users post is saved to it.

IF there isn't a local product table a new one will be created matching the users location, country or region.

15-3-D=IF the button is activated and the post has been saved to memory, then segue to page C else display in 1E “internet connection not available”.

15-3-D=Display photo or video along with its description is saved in 1E.

15-3-D=IF post is saved to the local products table, the following information will also be saved from user account information table: issuers ID, post ID and time stamp in the local products table.

15-3-D=If button is activated a function will save the following parameters to the users local product table product brand, product photo or video, product description, product ID and a query to users account information table will fetch the users issuers ID and save it all in one new row in the users local products table. The proper information will be queried in a conventional way, the tables help. Note as described in the table, the users issuers ID will be copied and pasted as the seller ID in the product table.

Products Table In Memory
Part 1

| | | | Product | Product | Product | |
|---|---|---|---|---|---|---|
| Definitions | Seller ID | Product ID | description | brand | rating | Comments |
| Value | Unique String | Unique string | String variable | String variable | Integer | String variable |
| Purpose | To identify the | To identify the | To describe | To tell | To tell | Allows buyers |
| | seller of a | product so it | the product so | potential | potential | to |
| | product so the | can be written | that potential | buyers the | buyers the | communicate |
| | equality | precisely in | buyers can | brand that is | experience | with each |
| | commission | invoice | understand if | behind the | other buyers | other freely |
| | function can | receipt. | they need | goods or | have had with | about their |
| | route the | | their product. | service. | the goods or | experience |
| | payment and | | | | services. | with the goods |
| | deduct the | | | | | or services. |
| | commission. | | | | | |
| | This one gets | | | | | |
| | copied from | | | | | |
| | issuer ID. | | | | | |

Part 2

| | | Photo or | | | | |
|---|---|---|---|---|---|---|
| | Class of | video of | | | | |
| Definitions | goods sold | product | Country | Time stamp | Price | Net gain |
| Value | String | Multi media | String | String | Decimal | Decimal |
| | | | | constant | variable | Variable |
| Purpose | This value is | This will be | It helps | It helps | The amount of | The amount of |
| | used in “select | displayed in | identify where | identify the | money to be | money to be |
| | your class of | FIG. 3. | the product is | last product | paid for a | split 50% to |
| | goods sold” in | | being sold. | uploaded. | product or | pay users for |
| | FIG. 1. | | | | service. | promoting a |
| | | | | | | product. |

### Operation FIG. 3-D

### Detailed Description

1-3-D=The text field has the message “product or service brand”. So the user knows what to enter in the text box below.

3-3-D=The conventional text field is for entering the product or service brand.

5-3-D=The conventional image view is for displaying the selected picture or video.

7-3-D=The conventional button is for selecting a photo or video from the users local memory.

9-3-D=The conventional text label has the message “description”.

11-3-D=The conventional text field is for describing the product.

15-3-D=The conventional button is for uploading to local posts the information required and saving to the product table, so users can sell their products or services.

### Part Names FIG. 3-F

### Detail Description

3-F=A conventional User interface.

1-3-F=A conventional text label.

3-3-F=A conventional button.

5-3-F=A conventional picker view or list view.

7-3-F=A Conventional button.

9-3-F=A conventional text field.

11-3-F=A conventional button.

### Conventional Screen Features

1H=A conventional screen clock.

3H=A conventional battery level indicator.

### Structure FIG. 3-F

### Detail Description

3-F=The conventional User interface for selecting a class of product or service.

1-3-F=The conventional text label tells the user to select one of the buttons for products or services.

3-3-F=The conventional button reads product because it will tell the processor to display names of product classes on 5-3-F from memory that has previously been written by the developer. In other words, this button triggers a sorting function that will narrow the search to the product class.

5-3-F=The conventional picker view or list view will display a list of names of products or services depending on the selection of the user.

7-3-F=The conventional button is for loading the service names in the 5-3-F list.

9-3-F=The conventional text field is for writing down the name of the product or service to narrow down the list.

11-3-F=The conventional save button is for saving to the respective tables in memory.

Product Table Region In Memory

| | | | Product | Product | Product | |
|---|---|---|---|---|---|---|
| Definitions | Seller ID | Product ID | description | brand | rating | Comments |
| Value | Unique String | Unique string | String variable | String variable | Integer | String variable |
| Purpose | To identify the | To identify the | To describe | To tell | To tell | Allows buyers |
| | seller of a | product so it | the product so | potential | potential | to |
| | product so the | can be written | that potential | buyers the | buyers the | communicate |
| | equality | precisely in | buyers can | brand that is | experience | with each |
| | commission | invoice | understand if | behind the | other buyers | other freely |
| | function can | receipt. | they need | goods or | have had with | about their |
| | route the | | their product. | service. | the goods or | experience |
| | payment and | | | | services. | with the goods |
| | deduct the | | | | | or services. |
| | commission. | | | | | |
| | This one gets | | | | | |
| | copied from | | | | | |
| | issuer ID. | | | | | |

### Function FIG. 3-F

### Detail Description

Low level description, a more technical discussion.

1-3-F=The conventional text label has the following message “Select product or service according to your class.”

3-3-F=The conventional button upon activation will trigger a function that will populate the list of 5-3-F with an array of strings containing the names of product classes.

The names available in the product's class array are food, clothing, games, detergents, cleaning equipment, beauty and others, this is just to name a few and in the future more will be added.

5-3-F=The conventional picker view or list view will be populated from 1 of 2 arrays of strings one contains product class names and one contains service class names.

This arrays will be handwritten by the developer.

7-3-F=The Conventional button upon activation will trigger a function that will populate the list of 5-3-F with an array of strings containing the names of service class. The names available in the service class array are cleaning, manufacturing, cooking, driving, plumbing, electrician, mechanic, barber, beautician, accounting, management, medical, legal, and others, this is just to name a few and in the future more will be added.

9-3-F=The conventional text field is for narrowing down the search in one of the arrays for it will be extensive. A sorting function will narrow down the search to matching terms.

11-3-F=The conventional button is for saving in the product table the following:

11-3-F=From the old row the one saved in the upload a product page copy all the information on to a new row and delete the old one.

Save the following in the product table in a new row: Seller ID(the user's issuer ID), product ID, product description, product brand, class of goods sold, photo or video. 11-3-F=The product table will be saved locally in the user's memory and there will also be a copy in the cloud.

The Local Product Table
Part 1

| | | | Product | Product | Product | |
|---|---|---|---|---|---|---|
| Definitions | Seller ID | Product ID | description | brand | rating | Comments |
| Value | Unique String | Unique string | String variable | String variable | Integer | String variable |
| Purpose | To identify the | To identify the | To describe | To tell | To tell | Allows buyers |
| | seller of a | product so it | the product so | potential | potential | to |
| | product so the | can be written | that potential | buyers the | buyers the | communicate |
| | equality | precisely in | buyers can | brand that is | experience | with each |
| | commission | invoice | understand if | behind the | other buyers | other freely |
| | function can | receipt. | they need | goods or | have had with | about their |
| | route the | | their product. | service. | the goods or | experience |
| | payment and | | | | services. | with the goods |
| | deduct the | | | | | or services. |
| | commission. | | | | | |
| | This one gets | | | | | |
| | copied from | | | | | |
| | issuer ID. | | | | | |

Part 2

| | | Photo or | | | | |
|---|---|---|---|---|---|---|
| | Class of | video of | | | | |
| Definitions | goods sold | product. | Country | Time stamp | Price | Net gain |
| Value | String | Multi media | String | String | Decimal | Decimal |
| | | | | constant | variable | Variable |
| Purpose | This value is | This will be | It helps | It helps | The amount of | The amount of |
| | used in select | displayed in | identify where | identify the | money to be | money to be |
| | your class of | on FIG. 3. | the product is | last product | paid for a | split 50% to |
| | goods sold in | | been sold. | uploaded. | product or | pay users for |
| | FIG. 1. | | | | service. | promoting a |
| | | | | | | product. |

This region in memory will be initialized and used as part of the tables of the database of the application as well as the other tables mentioned in this document.

This table will be stored in the users local memory of the current device the user is using.

This table will also be copied and its primary key will be the seller ID which is a copy of the user accounts information table issuer ID. The product table will also be stored in the cloud with other product tables from different countries. The proper information will be queried in a conventional way, the tables help.

### Operation FIG. 3-F

### Detail Description

1-3-F=The conventional text label tells the user to select the class of product or service.

3-3-F=The conventional button narrows the search results for products.

5-3-F=The conventional picker view or list view displays the names of products or services so the user can select one by clicking or tapping or touching.

7-3-F=The conventional button narrows the search results for services.

9-3-F=The conventional text field is there so the user can type a more specific service or product to narrow even further the class of goods sold.

11-3-F=The conventional button saves in memory the class of goods sold in the local products table so later the algorithm can place the products advertisement in the matching class of goods sold of a user's photo or video for a predetermined period of time.

### Part Names FIG. 3G

3G=A conventional user interface.

1-3G=A conventional text label

3-3G=A conventional text label

5-3G=A conventional text label

2-3G=A conventional text label

4-3G=A conventional text field

8-3G=A conventional text label

7-3G=A conventional text label

9-3G=A conventional text field

11-3G=A conventional text label

15-3G=A conventional button.

### Structure FIG. 3G

3G=The conventional user interface for entering price, cost and net gain.

1-3G=The conventional text label reads: “price”.

3-3G=The conventional text field is for displaying the computed price.

5-3G=The conventional text label reads: “Try matching your competitor's price people are more willing to buy from a fair price.”.

2-3G=The conventional text label reads: “Cost”.

4-3G=The conventional text field is for entering the cost of a product or service.

8-3G=The conventional text label reads: “How much does it cost to you? We will increase 5% to the cost to include our costs.”.

7-3G=The conventional text label reads: “Net gain”.

9-3G=The conventional text field is for writing the amount of net gain of the product or service.

11-3G=The conventional text label reads: “Net gain is what your willing to split 50% and spend in word of mouth advertising”

15-3G=The conventional button is for segueing back to page C the news feed.

### Function FIG. 3G

1-3G=The conventional text label reads: “price”.

3-3G=The conventional text field Is for displaying the computed price.

5-3G=The conventional text label reads: “Try matching your competitor's price people are more willing to buy from a fair price.”.

2-3G=The conventional text label reads: “Cost”.

4-3G=The conventional text field is for entering the cost of a product or service. The cost will be added to the net gain and the result will be saved in the variable named price to be displayed in 3-3G. Net gain and price are saved in the local products table.

4-3G=A algorithm calculate the 5% of the cost and add it to the cost. In other words it's the cost +5% of the cost.

8-3G=The conventional text label reads: “How much does it cost to you? We will increase 5% to the cost to include our costs.”.

7-3G=The conventional text label reads: “Net gain”.

9-3G=The conventional text field is for writing the amount of net gain of the product or service. Before storing in the local product table, the net gain will be added to the cost and the result will be stored in a variable named price to be displayed in 3-3G. The value of net gain is not to be altered because it will be stored and used later by the equality commission routing function.

11-3G=The conventional text label reads: “Net gain is what you're willing to split 50% and spend in word of mouth advertising”

15-3G=The conventional button is for segueing back to page C the news feed. Before the segue takes place. Query the seller's ID in product table to find the user's latest product ID. After you have the product ID and seller ID, add to the latest matching entry in the table the price and net gain. Then segue back to page C.

### Operation FIG. 3G

1-3G=The conventional text label reads: “price” so the user knows what to write in the text box below.

3-3G=The conventional text field Is for entering the desired price.

5-3G=The conventional text label reads: “Try matching your competitor's price, people are more willing to buy from a fair price.”.

7-3G=The conventional text label reads: “Net gain”.

9-3G=The conventional text field is for writing the amount of net gain of the product or service.

11-3G=The conventional text label reads: “Net gain is what your willing to split 50% and spend in word of mouth advertising”

15-3G=The conventional button is for segueing back to page C the news feed.

### Part Names Page F

### User Interface F

G=A conventional user interface page.

1G=A conventional text label.

3G=A conventional image view.

5G=A conventional button.

7G=A conventional text label.

9G=A conventional text field.

11G=A conventional text label.

15G=A conventional table View.

17G=A conventional back button.

19G=A conventional image view.

20G=A conventional text label.

### Conventional Screen Features

1H=A conventional screen clock.

H=A conventional level indicator.

### Structure Of FIG. 4

### Detailed Description

### User Interface F

1G is a text label that tells the user the brand of the product being displayed on screen.

3G is an image view that shows the user the product on screen.

5G is the purchase button, so users can buy the product they're currently viewing.

7G heading that literally says “description” on screen.

9G describes in a text paragraph the product currently on screen.

11G heading that literally says comments.

15G a table populated from memory showing all the comments of the product currently displayed on screen.

17G a back button that goes back to the news feed screen also named page C.

19G shows the user the rating the product displayed on screen has.

20G the conventional text label displays the product price of the product displayed on screen.

### Function Of FIG. 4

### Detailed Description

### High Level Function Page F

This Explains The Logic Of Page F In Simpler Terms

1G=Users can see the brand name of the product they selected on this text label.

3G=Here users can see the product they selected.

5G=Here the user can buy the product, and the equality commission function will pay the seller and promoter.

7G=This is the description heading.

9G=This is the description paragraph of the product.

11G=This is the comment's header.

15G=Here the comments are displayed.

17G=This button is for segueing back to the previous screen.

19G=This is where users can see the rating of the product they selected.

20G=The conventional text label displays the product price of the product displayed on screen.

### Low Level Function D

This explains the “how” of page D in more technical detail.

Page D is opened when the user taps on the advertisement seen on the news feed 7C Use the product ID to tell the computer what product to display in the equality store page.

1G=A function queries the product ID from the local user interactions table, to display the products brand name.

3G=A function queries the product image or video from the Local Products Table in memory using the product ID.

5G=First a function will query the local users Interactions Table to identify all the parties involved in the transaction: the issuer of the post or the issuer of the link to the post, the seller of the product or service, the product itself and finally the buyer, so all the proper information will be queried. A query from users Local Interaction Table will bring all the corresponding information from Local Interaction Table to the Transaction Table.

IF a transaction occurs, the information from the interactions table will be copied and pasted in to a new row in the Local Users Transaction Table with the product's price and net gain.

The purchase button then calls a payment function from the corresponding device framework or application programing interface.

### Buy Button Equality Function

IF the buy button is activated then a query to Local Users Interactions Table will query the issuers ID, buyers ID, seller ID, product ID, and product price. Then a query to Product Table to get the corresponding net gain.

The equality commission routing function will extract the commission of 50% of the net gain. The equality commission is to be paid to a user for making a sale or the user that shared a link or uploaded the post. Then the information is saved in The Transactions Table.

Equality Store Transaction Table
Part 1

| Definition | post issuers ID | buyers ID | Seller ID | Product ID |
|---|---|---|---|---|
| Value | String constant | String constant | String constant | String constant |
| Purpose | Identify the person | Identifies the | Identifies the | Identifies the |
| | that helped make | person that is | person or entity | product being sold |
| | the sale by sharing | interested in | that sells a product | for shipping and |
| | or uploading a | buying from | so the money can | accounting. |
| | post, for payment | person A's | be transferred | |
| | of the equality | advertisement. | upon a sale. | |
| | commission. | | | |

Part 2

| Commission | | | | |
|---|---|---|---|---|
| amount | Price | Net gain | Tax | Time stamp |
| Decimal | Decimal variable | Decimal | Decimal | String constant |
| variable | | Variable | variable | |
| The amount of | The amount of | The amount of | The amount of | Identifies the time |
| money to be paid | money a product | money to be split | money to be paid | the entry occurred. |
| to a user for | or service costs. | 50% to pay users | to local | |
| sharing a link to a | | for promoting a | governments for | |
| post or uploading a | | product. | doing business in | |
| post will be 50%. | | | their region. | |

### The Buy Button And The Equality Routing Function

The equality commission function will query first the Local Interactions Table for the purpose of identifying the buyer, the seller, and the promoter, also called, more technically, the person who uploads a post or shares a post.

The equality commission function will use this information to pay both the seller and the uploader, or sharer, of a post after the sale. In other words, the Equality Commission Function is going to pay the corresponding seller and the corresponding promoter of a post after a sale. The equality commission function will query the net gain and split in half, one half for the sharer or uploader of the post, and the other half to the seller. A query to the sellers ID to then store at the sellers Sales Table the value resulting from the subtraction of 50% of the net gain from the price. This stores at the local sales table the total gross sales.

7G=This is a label with a constant string that reads “description”.

9G=A function queries from the Local Interactions Table the product ID, to find in the local products table the product description to display in this text block.

11G=This text label is a constant value string that reads “Comments”.

15G=This is a conventional table view that has users comments.

### Populating User Comments Table

The user comments are retrieved from the Local Product Table comments row by first a query to Local Users Interactions Table to find the product ID in the last entry.

### Leave A Comment

IF the user taps or selects the first empty comment row in the table, it is an embedded conventional text field that the user can write his comment.

IF the user hits enter in his keyboard a function will be triggered to save the comment in the local product table. The local product table can be queried using the product ID in the local Equality Transaction Table to store the comment.

A function queries the local User Accounts Information Table to place the user's name before the comment in bold letters with different color and a semicolon followed by the user's comment saved in the local products table.

17G=The conventional back button that triggers a function that segues back to the news feed, also called page C.

19G=The function queries using the product ID in the Local Products Table to find in memory what rating image to display in the image window, this is computed with an average calculating algorithm. The average is used in a switch case statement to query an image from screen to be displayed in symbol of the average of users voted on the quality rating of this product.

The images are saved by the programmer in the memory consist of 4 stars for rating the product quality.

19G IF users swipe up or down on a rating image the value is saved in memory as a rating of the product name in memory. Or a text field input means that accepts numbers can be used in some devices.

19G The average calculating function reads the information in the rating column of the product table and returns the average value to 5D to be displayed so users can see the rating.

20G=The conventional text label displays the product price of the product displayed on screen. The product ID can be obtained from the last entry at the local interactions table. With the product ID a query to the local products table can be used to retrieve the product price and display on 20G.

### Operation FIG. 4

### Detailed Description

1G=Users can see the name of the product they selected on this text label.

3G=Here users can see the product they selected.

5G=Here the user can buy the product. The equality commission is paid to the promoter and seller.

7G=This is the description heading.

9G=This is the description paragraph of the product. Here the user can see the products description.

11G=This is the comments header.

15G=Here the comments are displayed. Here the user can see the comments and add their own comments.

17G=This button is for going back to the previous screen.

19G=This is where users can see the rating of the product they selected.

20G=This is the price of the product displayed on screen.

### Advantages

My solution to inequality helps reduce poverty, helps improve the quality of life of the working class. Helps the rich grow richer because the working class buys all the products and services from the wealthy. In America education is expensive, and so is health care and even food, in some areas, so all these problems can really see improvement with my technology.

### Description

I have a dream where income inequality is a thing of the past. Where we all have easy access to medicine, food and education.

Finally, I have found with technology a solution that will be shared with the world, a solution to income inequality. Equality helps the working class and makes the rich wealthier, Norway and Germany are proof of this. This concept can help the working class have more financial security, employed or unemployed. Anyone can be an influencer with this technology. The instances disclosed on this application use Windows, Apple iOS and Android OS, but it is possible to also use Linux OS or Chrome. It is also possible to deploy on web browsers, like Microsoft Edge, Firefox, Apple safari and google chrome. The goal is to reach as much people as possible to help them receive income equality opportunity.

### CONCLUSION RAMIFICATION AND SCOPE

While my above description contains many specificities, these should not be construed as limitations on the scope , but rather as an exemplification of one or several embodiments thereof. Many other variations are possible.

For example like the referenced provisional patent application stated other alternative embodiments a video game that pays users for causing a sale inside the game. The instances in this application create income equality accessible to most people with a smartphone or desktop computer a population that accounts to 3 billion people in the world and growing. People all over the world can have safer access to food, education and health care. People in many countries have much hardship obtaining these. I want to solve income inequality with the proper team of skilled and talented people. This patent can help secure the investment.

Accordingly, the scope should be determined not by the embodiments illustrated but by the amended claims and their legal equivalents.

1. Said software application for android, windows and apple OS family named social equality network written in native code paying up to 50% commissions to its users for sharing its post comprising of:
A native os coded function whit means for the last person to share a post to get the commission upon a sale is made in he's class of goods sold.
Means of using the hardware GPS of android, windows and apple family devices for setting geographic boundaries for sales representatives inside the equality network app. For the purpose of routing many sales to the smallest group possible of promoters whit similar class of goods sold.
For said equality social network apps purpose of limiting the amount of users in a class of goods sold per geographic region.
A user interface label that shows the last promoters brand who shared the photo or video content below.
A user interface for the user to select the class of goods sold that will limit him inside the app to sell only that respective class of goods sold for a short amount of time.
Means of a triggered function on tap of the promoters shared post. That routes the up to 50% commission to the last promoter who shared the post on the event of a sale of the promoters class of goods sold.
A store that pays up to 50% commissions per sale on the software app.
Said social equality network application whit a personality quiz for the means of promoting and selling to people whit you're same interests for free comprising of:
A means for free advertising in the said social equality network app as long as the product been sold is sold at the equality store inside the app.
Where by reducing poverty and unemployment by the payment of the up to 50% sales commissions. The use of the social equality network providing income equality for all educated and uneducated.
